(19) United States
(12) Patent Application Publication
(10) Pub. No.: US 2015/0263777 A1
(43) Pub. Date: Sep. 17, 2015

(54) SENSING CASE FOR A MOBILE COMMUNICATION DEVICE

(71) Applicant: Jacob Fraden, San Diego, CA (US)

(72) Inventor: Jacob Fraden, San Diego, CA (US)

(21) Appl. No.: 14/215,363

(22) Filed: Mar. 17, 2014

(51) Int. Cl. H04B 1/38

(52) U.S. Cl. CPC H04B 1/3888

(57) ABSTRACT

A protective case for enveloping a smartphone incorporates at least one sensor for detecting stimuli arriving from outside of the smartphone. The case and the phone form an integral unit that possess extra features than the phone alone wouldn't have. The sensor is supplemented by a signal conditioning and interface electronic circuit for communicating the sensed information to the smartphone inner processor. The communication is via a wired connection to the smartphone's connector or wireless via a radio waves or optical link. For expanding versatility of the smartphone, the sensors may be adapted for detecting non-contact temperature, light, ultrasonic, smell, material composition, human vital signs, and other signals.

This is a Continuation-in-Part of the U.S. patent application Ser. No. 13/740,261, filed on 14 Jan. 2013 and International PCT Patent application No. PCT/US14/11186 filed on 12 Jan. 2014. It claims the priority of a provisional U.S. patent application No. 61/737,739 filed on 15 Dec. 2012. The disclosures of the prior related applications are hereby fully incorporated by reference herein.

### FIELD OF INVENTION

This invention relates to mobile communication devices, more specifically to accessories for handheld smartphones.

### DESCRIPTION OF PRIOR ART

Smart telephones became more and more versatile. Nowadays in their versatility, smart telephones resemble a Swiss Army Knife—a multi-function and multi-purpose item. Most wireless communication devices (cellular or mobile telephones, e.g.) incorporate additional non-communication features, such as imaging (photo and video), personal planners, games, navigation, etc. There are numerous inventions that attempt to include more features for measurement and/or monitoring external signals such as temperature and air pressure. An example is the electromagnetic radiation sensors as taught by the U.S. Pat. No. 8,275,413 issued to Fraden et al. and incorporated herein as reference. Especially of interest for practical applications are medical uses of the smartphones for patient monitoring, self-diagnostic and treatment.

For a chemical analysis and material composition a mass-spectrometry can be employed. A recent advancement in the MEMS technology allowed a construction a miniature sensor responsive to a single molecule as described in A. K. Naik et al. “Towards single-molecule nanomechanical mass spectrometry”. Nat. Nanotechnol. 4, 445-450 (2009). This chip can be incorporated in a mobile communication device or a carrying case.

Certain medical monitoring detectors can be imbedded directly into a smartphone and become an integral part of such. Yet, many more shouldn't be integrated into mobile communication devices (smart phones, e.g.) for various reasons. The key reason why all smartphones should not comprise a multitude imbedded sensors is a pure practicality. At least in a foreseeable future, many sensors would take a valuable space and increase cost—often this makes not much sense for a generic smartphone that is intended for a general population. Being “smart’ is good and beneficial, but being “too smart” is not always useful. For example, an air pressure or noncontact infrared temperature measurements may be very useful features during activities of certain phone owners (in a work place, hospital, travel, e.g.), yet they would not be needed at all for many other users that are not engaged in such activities. Incorporating monitors and sensors into smartphones while technically feasible, would increase cost, cause larger overall dimensions and reduce reliability. Further, numerous smartphone models being already in service, can't be retrofitted for adding the extra sensing features. One approach to this issue would be a use of an external attachment to a conventional telephone. However, such attachments may not be convenient for carrying around (and most consumers would never do that), are relatively bulky and require extra efforts for attaching and maintenance. Another and more practical approach is to imbed additional sensors and detectors into a conventional everyday accessory that is routinely used with a smartphone. Such a commonly used accessory is a protective jacket or case that envelops the exterior surface of a phone and absorbs impact forces if dropped on a floor. Most of such covers are designed just for a mechanical protection of the phone. However, the phone covers that in addition to their protective properties incorporate extra electronic circuitry are known in art and exemplified herein by the following. The U.S. Pat. No. 5,517,683 issued to Collett teaches an extension system that implements the additional electronic functions in a case attachable to an external surface of the cellular phone to form a physically integral unit with a connector to couple the extension electronics to the cellular phone electronics. U.S. Pat. No. 8,086,285 issued to McNamara et al. teaches a sound enhancing feature in a protective case. A phone case with electrical lights is taught by the U.S. Publication No. 20120302294 issued to Hammond et al. The U.S. Publication No. 20120285847 issued to Ollson teaches use of an electronic devices inside a protective case. U.S. Publication No. 20120088558 issued to Song et al. teaches an extra battery incorporated inside a protective case. A US company AliveCor (“alivecor.com”) developed the ECG screening monitor incorporated into a protective smartphone jacket. All foregoing patents, publications and the company are incorporated herewith as references. These devices and other inventions on record and known commercial products fail to address sensing a variety of external signals by a smartphone protective case.

Generally, there are two types of sensors that can be either imbedded into a smartphone or protective jacket. The sensors of the first type are responsive to external electrical signals, like voltage or charge, as exemplified by the above referenced the ECG screening monitor from AliveCor. The second type sensors are responsive to non-electrical external stimuli, for instance: pressure, chemical composition, temperature, light, as exemplified by the above referenced U.S. Pat. No. 8,275,413. The latter sensor type is characterized by a complex sensor design comprising at least one transducer of non-electrical energy to electrical signal, for example, a thermopile that converts the absorbed infrared light to heat, then coverts heat to electrical signal.

Thus, it is an object of the present invention to provide a protective cover for a smartphone that incorporates additional sensors and/or actuators for detecting property of the outside space.

Another goal of the invention is to develop a smartphone protective cover that can sense ECG signals with no physical contact with the patient body.

Further and additional objects and goals are apparent from the following discussion of the present invention and the preferred embodiments.

### SUMMARY OF THE INVENTION

A protective case for holding a smartphone incorporates at least one sensor for detecting signals caused by the stimuli from a space being external to the smartphone. The stimuli may be electrical or non-electrical. The case and the phone form an integral unit that possess the sensing features that the phone alone doesn't have. The sensor is supplemented by a signal conditioning and interface electronic circuit for communicating the sensed information to the inner processor of the smartphone. The communication may be via a wired connection to the smartphone connector or wirelessly via a radio wave or optical link. For expanding versatility of a smartphone, specific sensors imbedded into a protective sensing case may be adapted for detecting non-contact temperature, light, ECG, smell, chemical composition, ultrasonic and other external stimuli.

### BRIEF DESCRIPTION OF DRAWINGS

FIG. 1 illustrates isometric views of the back and front sides of a sensing case;

FIG. 2 is an illustration of a coupling of an internal connector to a sensing module;

FIG. 3 presents a diagrammatical view of mutual dispositions of the components;

FIG. 4 shows a top positioning of a sensing module;

FIG. 5 is a block-diagram of a module for sensing thermal radiation;

FIG. 6 is a block diagram of a sensing case for sensing thermal radiation and ECG;

FIG. 7 is a cross-sectional view of a capacitive dry ECG electrode;

FIG. 8 illustrates a ground electrode;

FIG. 9 illustrates an isometric view of a smartphone case with a removable top;

FIG. 10 is an isometric view of a case with a folding flap, containing a sensor;

FIG. 11 is a case with a feedback component;

FIG. 12 illustrates incorporation of a optical sensor into a phone case;

FIG. 13 shows a sensor protected by a lid.

FIG. 14 illustrates a case with test strips for blood glucose

FIG. 15 is a block diagram of a camera and the sensing case connected to the processor

FIG. 16 shows the operational flow chart of the phone and case combination.

### PARTS LIST FOR FIGS. 1-13

| | |
|---|---|
| 1 | back side |
| 2 | front side |
| 3 | camera opening |
| 4 | back wall exterior |
| 5 | back wall interior |
| 6 | connector |
| 7 | IR sensor lens |
| 8 | side extension |
| 9 | sensing module |
| 10 | wiring harness |
| 11 | upper part |
| 12 | receptacle |
| 13 | slots |
| 14 | flat battery |
| 15 | smartphone |
| 16 | phone connector |
| 17 | link |
| 18 | ECG converter |
| 19 | openings |
| 20 | top extension |
| 21 | sensing jacket (case) |
| 22 | thermopile detector |
| 23 | signal conditioner |
| 24 | encoder |
| 25 | back wall |
| 26 | first ECG electrode |
| 27 | second ECG electrode |
| 28 | amplifier |
| 29 | signal conditioner |
| 30 | signal converter |
| 31 | electrode plate |
| 32 | isolator |
| 33 | follower |
| 34 | driven shield |
| 35 | electrode housing |
| 36 | follower output |
| 37 | bottom part |
| 38 | upper part |
| 39 | coupler one |
| 40 | coupler two |
| 41 | joint |
| 42 | back case |
| 43 | flap |
| 44 | flap thickness |
| 45 | pivot |
| 46 | mating portion |
| 47 | ground electrode |
| 48 | ground amplifier |
| 49 | output device |
| 50 | sensor |
| 51 | lid |
| 52 | axis |
| 53 | directions |
| 54 | wireless module |
| 55 | 1^{st} LED |
| 56 | 2^{nd} LED |
| 57 | photo detector |
| 58 | filter |
| 59 | processor |
| 60 | and 60a camera |
| 61 | display |
| 62 | test strip |
| 63 | pocket |
| 64 | current source |

### DESCRIPTION OF PREFERRED EMBODIMENTS

In the following description, the words “smartphone”, “cell phone”, “phone” and “mobile communications device” are used interchangeably and generally have the same meaning. Likewise, words “case”, “cover” and “jacket” refer to the same item.

FIG. 1 illustrates the back, 1, and front, 2, sides of a protective case, 21, for holding a mobile communication device (a smartphone, e.g.). The case is designed for a snag fit over at least a portion of the exterior of a phone and not to interfere with its normal functions. Toward this goal, the case, 21, has one or more slots and openings, 13 and 19, for the phone controls, switches, microphone/speaker, etc. To protect the phone against damage, if dropped, the case is fabricated of an impact resistant and stress absorbent material. Examples are polyurethane, phenolics and polycarbonate. Such materials are well known in art and not described herein. A front side of the case, 21, is open for providing access to the phone display and controls, while the rear side preferably (but not necessarily) is protected by a wall having the back side, 4, and front side, 5. The connector, 6, may be incorporated inside the case, 21, for coupling to the smartphone. On the upper side of the case, a side extension, 8, is shown. It is for housing certain components that will be described below. A shape and location of the side extension, 8, is arbitrary and depends on the ergonomic, esthetic and engineering requirements to the device.

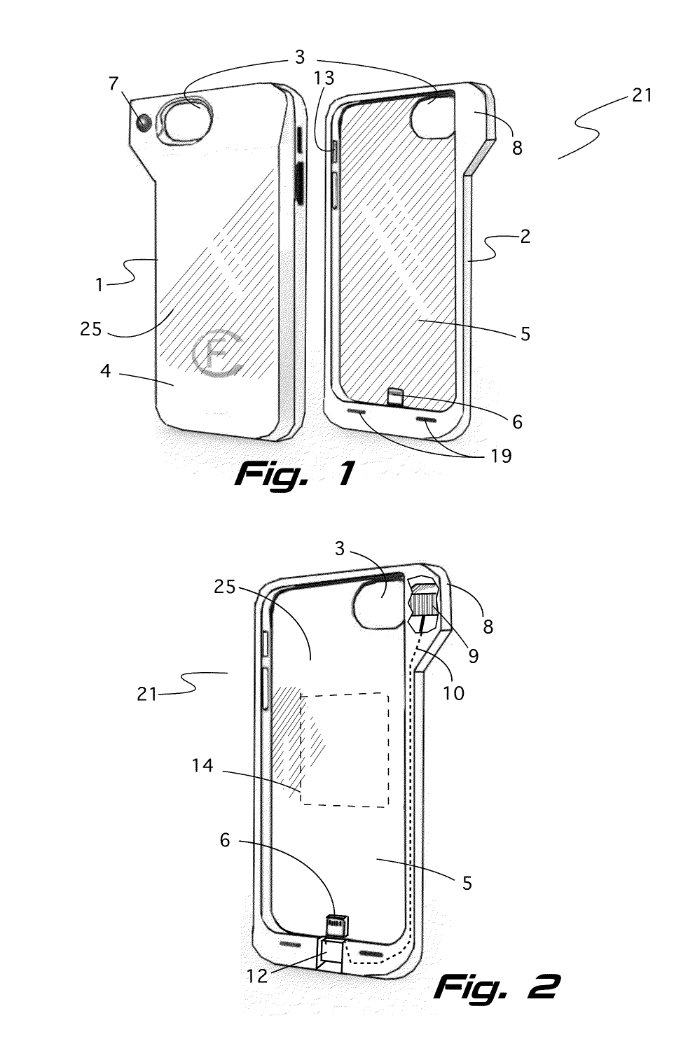

FIG. 2 shows the case, 21, that inside the side extension, 8, incorporates a module, 9, that may comprise one or more sensors of the external stimuli and supporting electronic circuits to perform additional functions for the phone. Examples of such components are: a thermopile detector for sensing thermal (infrared) radiation, air pressure sensor, UV light detector, signal converter, electromagnetic field detector, electrical resistance, current and voltage, blood pulse oximeter, blood glucose meter, detector of a chemical composition, and many others. A spectrum of the detected electromagnetic field may range from UV to long waves to static electrical and magnetic fields. Some sensors require an opening in the module to access the outside space. The module, 9, communicates with the smartphone (not shown in FIG. 2) through the connector, 6, that is attached to the module via a wiring harness, 10, such as a flexible circuit strip, e.g. The connector, 6, may be directly attached to a receptacle, 12, that allows electrical connection of the smartphone to a peripheral equipment, for example, a battery charger or external computer. Optionally, an additional battery, 14, may be incorporated inside the case, 21, for example, inside the back wall, 25.

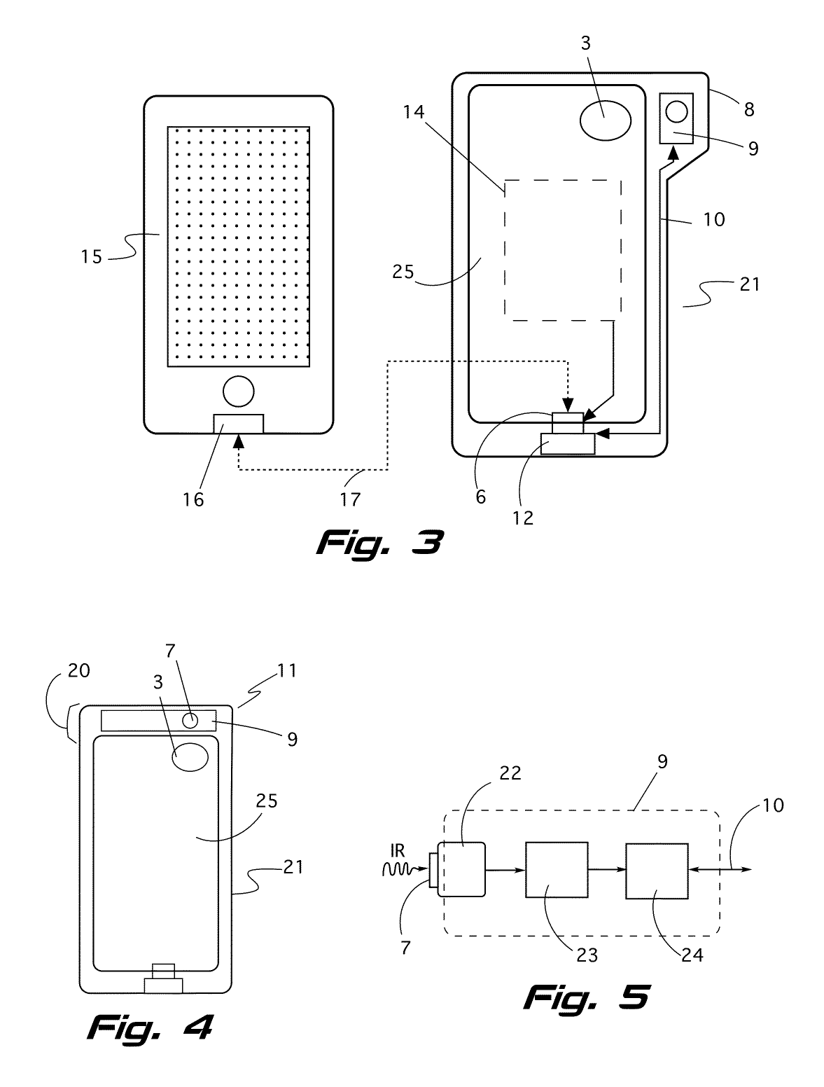

Before operation, smartphone, 15, in positioned inside the case, 21, with the phone inner connector, 16, being coupled to the case connector, 6, as illustrated in FIG. 3. For clarity only, the smartphone, 15, is shown outside of the case, 21 while the coupling is shown by a broken line, 17.

Alternatively, the smartphone, 15, may communicate with the module, 9, by a wireless means, for example by using a bidirectional radiofrequency or optical coupling. In that case, the module, 9, and smartphone, 15, incorporate appropriate coupling components that are well known in art and thus not described here. As a result, the connector, 6, and wiring harness, 10, will not be required for a wireless communication between the case and the smartphone.

Optionally, sensing module, 9, may be positioned in other areas of the case, 21, for example, inside the back wall, 25, or at the upper part, 11, as shown in FIG. 4. The latter placement will require a top extension, 20. Positioning of the module, 9, (or 10) depends on particular applications. For example, for a noncontact temperature measurement, lens, 7, of the IR detector should be positioned as close as practical to the digital camera lens protruding through the opening, 3. This closeness reduces parallax and allows superimposing the fields of view of the IR and digital cameras.

The sensing module, 9, may be responsive to a variety of signals, including ionizing radiation and electromagnetic fields in various spectral ranges, including UV, IR, microwave and radio-frequency (RF). One of many potential applications of the RF version of module, 9, is a remote electronic key that can lock and/or unlock a car door or start the engine. In that case, the sensing module contains a transmitter/receiver of the RF signal and appropriate codding/decoding circuit whose design and operations are known in art and thus not described herein.

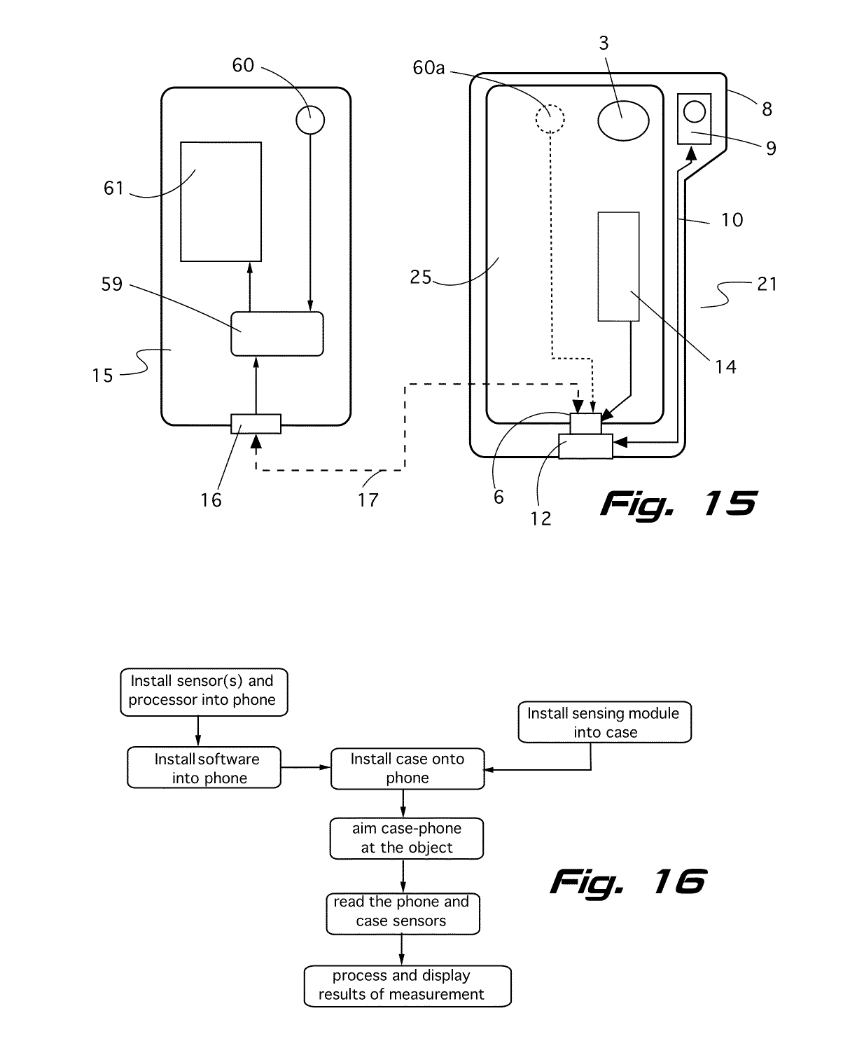

If the jacket comprises a module, 9, that for its operation requires certain disposable or reusable components (see FIG. 14), the jacket my be appended with a pocket, 63, for storing such removable test components. An example is a set of disposable test strips for a glucometer (monitor of blood glucose). To take a reading, one test strip, 62, is removed for the pocket, 63, and inserted into a slot in the sensing module, 9. Then a drop of blood is applied to the strip, 62, for reacting with the strip internal chemical compounds. The module, 9, responds to a chemical reaction between blood and the compounds and communicates results to the processor of the smartphone (not shown in FIG. 14). Likewise, certain actuators, either manual or electrical, also can be imbedded into the jacket. An example is a piercing blade (a blood lancet) for puncturing the patient skin to obtain a blood sample for the glucometer.

Most of the sensors imbedded into the case, 21, can't be directly coupled to the connector, 6, and thus require intermediate (interface) electronic circuits, such as signal conditioners, amplifiers, analog-to-digital converters, encoders, etc. As an illustration, FIG. 5 shows module, 9, incorporating the thermal IR detector, 22, with the infrared lens, 7. The detector receives the incoming IR radiation and converts it into electric voltage that is fed to the signal conditioner, 23, that in turn is connected to the encoder, 24. Typically, the signal conditioner, 23, is comprised of an amplifier and filter, while the encoder, 24, is comprised of an analog-to-digital converter and a code adapter for matching a signal format in wiring harness, 10, with the signal format compatible with a particular model of a smartphone for which the case, 21, is intended. The sensor (a thermopile, e.g.) not necessarily should be part of the module, 9. For practical reasons in some embodiments, it may be externally positioned with respect to the module.

In example of FIG. 5, a non-electrical stimulus (IR radiation) is converted by a thermal radiation sensor (thermopile, micro-bolometer, etc.), 22, first to heat and subsequently heat is converted to a small electrical voltage that is substantially proportional to the intensity of IR radiation received by the detector, 22. In other embodiments, a stimulus may be of an electrical nature, for example, electro-cardiographic (ECG) voltage naturally appearing over the patient's chest.

To process and display information that is produced by the sensing module, 9 (FIG. 15), the module, 9, output signal is communicated to the smartphone, 15 (display, e.g.), either via a phone connector, 16, or wirelessly, for example via a Bluetooth or NFC. This information is fed into the smartphone processor (computer), 59, which also may receive signals from the smartphone own sensors, such as magnetometer, accelerometer, gyroscope or digital camera, 60. Alternatively, the digital camera may be incorporated into the jacket, 21, as indicated by a broken line, 60a. It is one important feature of this invention that both signals from sensors embedded into a smartphone and from sensors embedded into the case are fed into the phone processor, 59, for processing. An example of processing of both signals is enhancement of a thermal imaging signal received from module, 9 (assuming that the module contains a thermal imaging camera), by the digital image signal received from the visible image camera, 60 (or 60a). Another example is use of the digital camera image for correct aiming of the IR sensor at the space where thermal radiation is generated (human forehead, e.g.). Flow chart of FIG. 16 further illustrates this function. It shows that different sensors are installed into both the phone and the case. Then, the case and the phone are mated: the case is installed over the phone. During operation, the case sensor is either brought into vicinity of the object or aimed at the object of measurement. This enables sensors from both the phone and the case to receive stimuli that represent certain properties of the object and the phone computer can process them together or separately. The list of properties may include thermal or ionizing radiation, chemical composition, mutual disposition, brightness, colors, electromagnetic radiation, pressure and any other property of matter. The internal phone computer, 59, processes the signals and sends results to the output device, such as display, 61.

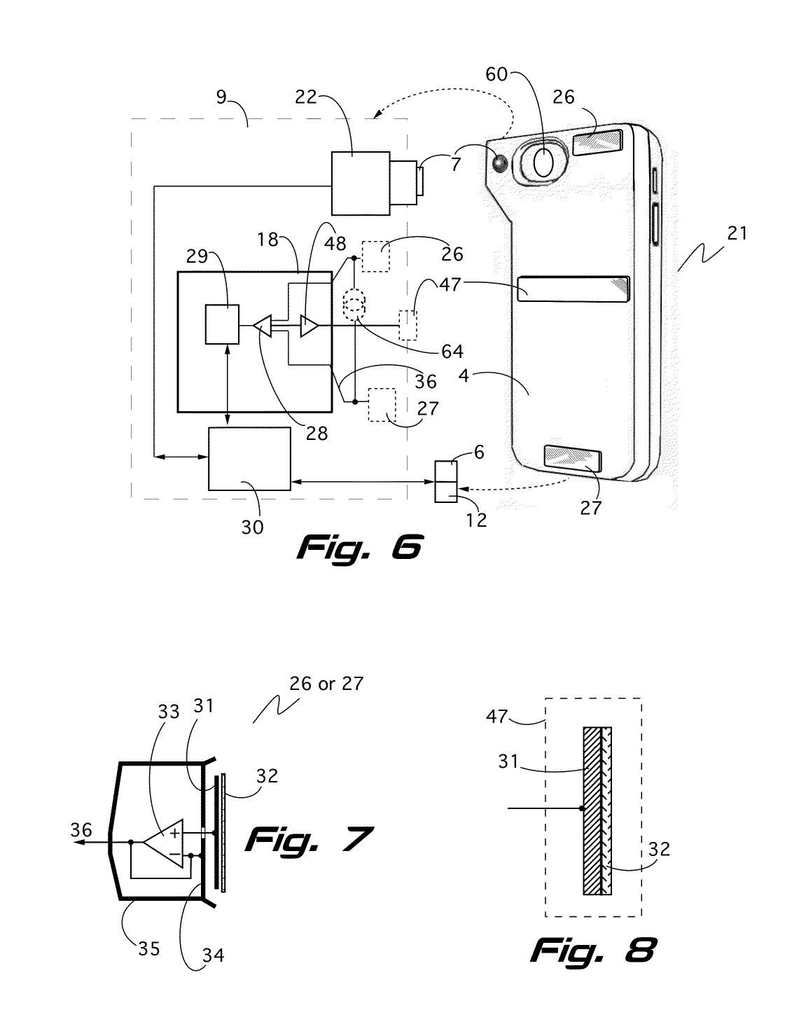

To illustrate operation of a sensor responsive to the ECG electrical stimuli, FIG. 6 shows the case, 21, that on the back wall exterior, 4, incorporates three non-contact ECG electrodes, 26, 27 and 47. The electrodes may be simple metal plates or they can be designed in a more complex form as shown below. For clarity, module, 9, and the electrodes are shown as removed from the case, 21, although in reality they are incorporated into the case. Note that more than one type of sensors may be incorporated into the same case, 21. This is illustrated by a thermopile detector, 22, (for thermal radiation) being part of the module, 9, with the IR lens, 7, protruding through the case, 21. The thermopile detector is in addition to the ECG electrodes and electronics.

Electrical signals from the ECG electrodes are amplified by the amplifier, 28, processed by the signal conditioner, 29 and converted to a digital format by the signal converter, 30. The same converter may be used to convert signals from the thermopile detector, 22. The digital signals pass to the connector, 6, and subsequently appear at receptacle, 12, for connecting to the external peripheral devices, if needed for calibration, e.g.

During operation, the non-contact active electrodes 26 and 27 and the ground electrode, 47, are pressed against the patient chest. Here term “non-contact” means that the conductive portions of the electrodes make no direct electrically conductive contact with the patient skin. Fundamentals of such an electrode system can be found in: Yu M. Chi et al. “Wireless Non-contact Cardiac and Neural Monitoring.” Wireless Health 2010, October 5-7, 2010, San Diego, USA.

A more detailed schematic of an active non-contact capacitive electrode (26 or 27) is illustrated in FIG. 7. Word “active” here means having an imbedded electronic circuit. The electrode is comprised of an electrode plate, 31, that is made of a conductive material (metal or conductive polymer, e.g.), isolator, 32, voltage follower, 33, driven shield, 34, and the electrode housing, 35. Note that isolator, 32, should be thin (on the range of 1-10 mkm) and composed of an electrically non-conductive material having as high dielectric constant as practical, preferably more than 20. A high dielectric constant increases a capacitance between the patient skin (not shown) and the electrode plate, 31, thus improving quality of the recorded ECG signals at the lower part of the frequency spectrum. Examples of suitable materials for the isolator, 32, are certain ceramics, such as titanium dioxide (rutile) deposited on the electrode plate, 31. Thus, the electrode plate, 31, and isolator, 32, forms a unitary two-layer structure. Input of the voltage follower, 33, is connected to the electrode plate, 31, while the follower's output, 36, is connected to the electrically conductive driven shield, 34, and preferably to the electrode housing, 35, which also should be made of the electrically conductive material. The voltage follower, 33, has a very high input impedance on the order of several Gigohm and a very low output impedance in the ohm range. This assures a sufficiently low cut-off frequency of the electrode and lower interferences. Note that driven shield, 34, is well isolated from the electrode plate, 31, but both are at substantially the same voltage (potential), thanks to a unity gain of the voltage follower, 33. “Substantial” here means be within 1% from one another. As a result, any stray capacitance between the driven shield and electrode plate becomes immaterial and makes no effect on the recorded signal.

A capacitance between the electrode plate, 31, and the patient body provides a capacitive coupling for the ECG varying voltage. A voltage difference between the electrodes, 26 and 27, is amplified and in a digital format is fed to the smartphone inner electronics for processing. Note that the ground electrode, 47, is driven by the ground amplifier, 48. The ground electrode construction is shown in FIG. 8. Like an active electrode of FIG. 7, it also contains a conductive electrode plate, 21, and insulator, 32.

Note that thanks to very high input impedance of the voltage follower, 33, it may take a long time for an ECG signal to settle down for a normal recording after the case, 21, being placed onto the patient chest. This transition time can be significantly reduced by a momentary shorting together the electrode plates, 21, of both active electrodes, 26 and 27, to the electrode plate of the ground electrode, 47. This can be accomplished by a set of additional solid-state switches that are not shown in the drawings because details of the capacitive electrode design go beyond the scope of this disclosure.

For measuring some vital signs (respiration, blood flow, arterial pressure, electrical stimulation, etc.) in relevant medical applications, it may be desirable to measure the subject body impedance between the conductive plates 26 and 27 (FIG. 4) or pass through the plate a stimulating d.c., a.c. or pulsing electric currents. For such applications, a direct or alternate current source, 64, is attached to the electrodes, 26 and 27, for passing electric current through the subject's body when the electrodes are in contact with the patient (subject) body surface.

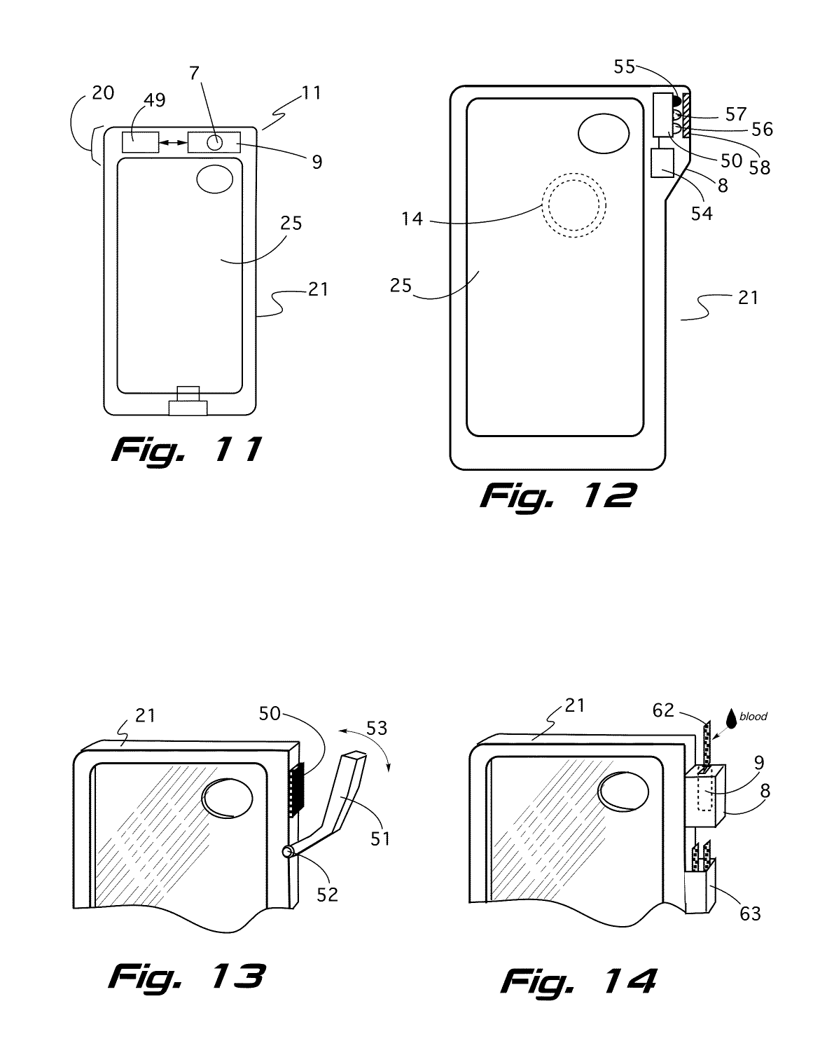

Even though the mobile communication device (smartphone, e.g.) usually has a means for communication with the user, it may be beneficial to supplement the sensing case, 21, with an additional output device, 49 (FIG. 11), comprising one or more of the following: LCD, LED, speaker, vibrator. One example of the functionality of such an output means is providing a feedback to the user in case when communication with the smartphone can't be established.

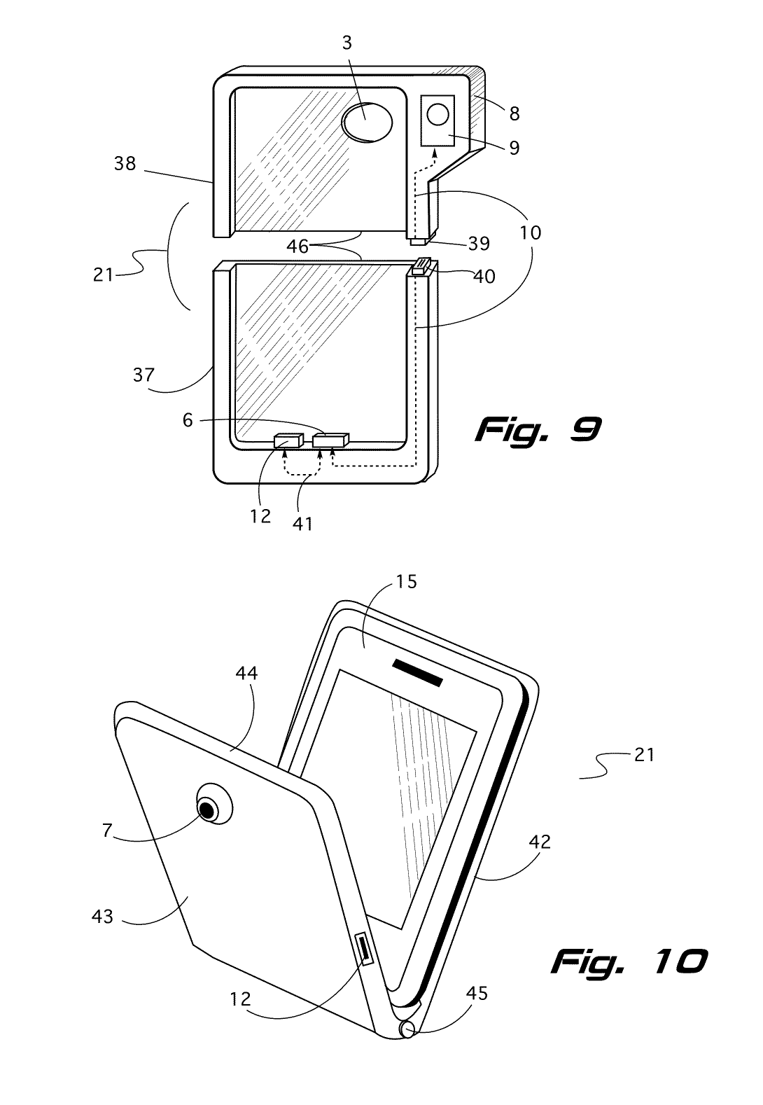

Case, 21, can be designed in many modifications without departing from the key principles and spirit disclosed herein. As an illustration, FIGS. 9 and 10 illustrate two other embodiments of the invention. The embodiment of FIG. 9 shows a two-part case, 21, comprising the bottom part, 37 and the upper part, 38, where one part is fully detachable from another. During operation, both parts are slid over the smartphone housing and joined together. A sensor (or several sensors) can be positioned either in one part or both parts. If necessary, to assure continuity of the wiring harness, 10, at a mating portion, 46, of the case, 12, a coupler one, 39, is mated with a coupler two, 40. The couplers are the interconnecting devices. Note that the receptacle, 12, may be separated from connector, 6, and linked to it by an electrical joint, 41. The embodiment of FIG. 10 also shows a two-part case, 21, where both parts are joined together and can mutually rotate around pivot, 45. The back case, 42, envelops a portion of the body of a smartphone, 15, while flap, 43, may carry one or more sensors as illustrated by an optical sensor having the IR lens, 7. The receptacle, 12, may be located on the either part of the case, like on the flap, 43, as shown in FIG. 10. The flap thickness, 44, should be sufficient for housing all needed sensors and supporting electronic components.

FIG. 12 illustrates another embodiment of this invention comprising an optical sensor, 50. Note that the optical sensor can have a multitude configurations and applications and may operate in various portions of the optical spectral range—from UV to far infrared. As an example, FIG. 12 shows an optical sensor, 50, adapted for measuring percentage of a human hemoglobin oxygenation by a method of a pulse oxymetry. It incorporates a near IR light emitting diode—1^{st} LED, 55, a red light—2^{nd} LED, 56, and a photo detector, 57. These components are protected by an optical filter, 58, that is transparent in the near IR and red portions of the light spectrum. For measuring a hemoglobin oxygenation, the filter, 58, is pressed against a portion of the patient body, a finger tip, e.g. The method of pulse oxymetry is well known in art and thus not further described herein. Note that in this illustration, the case, 21, has no wired connection to a mobile communication device, but is connected to it via a wireless module, 54 (a “Bluetooth”, e.g.). Since there is no wired connection to a mobile communication device, electric power to the components incorporated into the case, 21, may be provided by a flat battery, 14, imbedded into the back wall, 25.

An optical sensor as described herein can be adapted for monitoring a heart rate of a human or animal subject by detecting a variable (modulated) light by the photo detector, 57. Alternatively, a heart rate me be computed from an R-wave of the ECG signal as detected by the embodiment shown in FIG. 6.

Some sensors after being incorporated into case, 21, may be quite delicate, thus requiring an additional protection from environment. This can be accomplished by appending case, 21, with a protective lid, 51, shown in FIG. 13. The lid, 52, can swing in directions, 53, around axis, 52 to an open and closed positions. If needed, the lid, 52, may incorporate certain additional components, like a photo detector, e.g. (not shown in FIG. 13).

While the present invention has been illustrated by description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims.

1. A protective case for a mobile communication device, the protective case comprising:
an impact-resistant material configured to removably wrap around at least an external portion of a housing of the mobile communication device, the mobile communication device comprising a digital imaging camera that generates a digital visible image signal of a visible image of a space outside of the case;
a sensing module generating a second signal representing a property of the space;
an extension having an internal cavity that houses the sensing module,
wherein the protective case is adapted for providing an alignment of the sensing module with the digital imaging camera and the space, and
the digital visible image signal and the second signal are communicated to a computer of the mobile communication device for processing to determine the property of the space based on the digital visible signal and the second signal, and
the property of the space is selected from the group consisting of electromagnetic radiation, electric voltage, chemical composition, and ionizing radiation.

2. The protective case of claim 1, wherein the digital imaging camera is enabled for aiming the sensing module at the space.

3. The method of claim 25, wherein the sensing module receives a stimulus selected from a set comprising ionizing particles, thermal radiation, electromagnetic radiation in UV spectral range, radio-frequency electromagnetic field, magnetic field, electrical resistance, voltage, electric current, pressure, composition of materials, light, and sound.

4. (canceled)

5. The method of claim 25, further providing a communication circuit that wirelessly couples the sensing module to the mobile communication device.

6. The method of claim 25, further providing an output device selected from a group consisting of a light source, liquid crystal display, vibrating device, and sound generating device, such output device being incorporated into the case.

7. (canceled)

8. (canceled)

9. (canceled)

10. (canceled)

11. (canceled)

12. (canceled)

13. (canceled)

14. (canceled)

15. (canceled)

16. The method of claim 25, further providing a source adapted for generating and transmitting the electromagnetic radiation toward the space.

17. (canceled)

18. (canceled)

19. A protective case for a mobile communication device, the protective case comprising:
an impact-resistant material configured to wrap around at least an external portion of the housing of the mobile communication device, the mobile communication device comprising a digital imaging camera that generates a digital visible image signal of a visible image of the space outside of the case;
a sensing module responsive to thermal radiation and generating a second signal representing a thermal radiation of the space;
an extension having an internal cavity that houses the sensing module;
wherein the protective case is adapted for aligning the digital imaging camera with the sensing module, and digital imaging camera is adapted for aiming the sensing module at the space, the digital visible image signal and the second signal are communicated to a computer of the mobile communication device for processing to determine the thermal characteristic of the space based on the digital visible image signal and the second signal.

20. (canceled)

21. (canceled)

22. (canceled)

23. The method of claim 25, wherein the second sensor comprises at least two electrically conductive plates attached to the wall, wherein the property of the space is electrical.

24. The method of claim 25, wherein the second sensor is an infrared thermometer and the second signal represents temperature of the space.

25. A method of measuring a property of a space, comprising the steps of:
providing a mobile communication device incorporating a housing, a processor, an output device and a first sensor having an angle of sensing and generating a first signal;
providing a removable case comprising an impact-resistant material and having a wall, such case being adapted for coupling to at least a portion of the housing and comprising a cavity for housing a second sensor;
installing the second sensor into the cavity, such sensor is adapted for generating a second signal related to the property of the space;
attaching the case to the mobile communication device by mutually aligning the angle of sensing with the second sensor and the space;
positioning the case in the vicinity of space;
generating the first and second signals and communicating them to the processor for a joint processing to produce a third signal representative of the property of the space, and
coupling the third signal to the output device.

26. The method of claim 25 wherein the first sensor is a digital camera.

27. The method of claim 25 further providing the steps of
providing a disposable test component;
incorporating a compartment in the case for storing at least one test component;
coupling the test component to at least a portion of the space;
aligning the test component with the first and second sensors for generating the first and second signals and communicating them to the processor.
